(19) United States
(12) Patent Application Publication
(10) Pub. No.: US 2010/0322251 A1
(43) Pub. Date: Dec. 23, 2010

(54) Method and System for Virtually Switching Digital Video/Audio and Auxiliary Control Signals for Digital Signage Applications

(76) Inventor: Changrong Li, (US)

Correspondence Address: Changrong Li, 10710 Cassia Dr., Austin, TX, 78759, US

(21) Appl. No.: 12/489,143

(22) Filed: Jun. 22, 2009

(51) Int. Cl. H04L 12/56

(52) U.S. Cl. 370/395.53

(57) ABSTRACT

This invention is to use managed Ethernet switches, such as the 100 Megabit, 1 Gigabit, or 10 Gigabit Ethernet switches, to create virtual video switches for digital signage applications. Video switching is accomplished through dynamically configuring port-based virtual local area networks (VLAN). A dedicated VLAN is created for each video source to broadcast the video. All the digital signage displays joined to the VLAN will display the same content. The connection and removal of displays from the VLAN is controlled by centralized software. A converter at the video source converts the pre-compressed video source into Ethernet frames, or a compressor at the video source compresses the raw video in real time into Ethernet frames to be sent over the Ethernet switches. A decoder at the receiving side decodes the incoming Ethernet frames and outputs uncompressed digital video for display. Auxiliary control signals, such as serial ports, USB mouses, USB keyboards and generic I/O controls normally associated with digital signage applications, can also be switched in parallel with the video/audio. Compared to custom-designed video switches, Ethernet switches are widely available and inexpensive. Ethernet switches of various sizes, like 4, 8, 16, 32, 64 ports, etc., can be used in this way to create virtual video switches of virtually any size. Ethernet switches can be either stacked together at the same location to create a centralized video matrix switch or linked together through high-bandwidth trunks to create a distributed virtual video switch. Furthermore, while specialized video cable, such as coaxial or HDMI cables, can be rare and costly, Ethernet cables are widely available and inexpensive. The Ethernet cable is also the standard communication wiring in modern buildings, and is, in many cases, pre-wired. Overall, this virtual video switch solution increases flexibility and reduces engineering costs for digital signage applications.

### FIELD OF THE INVENTION

The present invention relates to a method for the virtual switching of digital video/audio and auxiliary control signals for digital signage applications utilizing port-based broadcast Virtual Local Area Networks (VLAN) and a virtual switching system comprising of one or more managed Ethernet switches.

### BACKGROUND OF THE INVENTION

The simplest digital signage application is composed of a display directly connected to a source that can be controlled locally, such as a LCD monitor connected to a Personal Computer (PC). If the display and source are located more than a certain distance from each other, the video/audio and auxiliary control signals must be extended. This is usually achieved by using specially designed extenders and cables.

Most digital signage applications are composed of more than one display. These displays are usually located separately and connected to the source through a video distribution system composed of specially designed splitters, extenders, and cables.

If displays need to display contents from different sources over different time periods, a video switch must be used. A full-featured digital signage application usually comprises of multiple sources and displays, video switches, splitters, extenders, and cables. This equipment must be specially designed for the professional AV market and is expensive.

With the advent of digital video and the Internet, new methods to deliver content are often used in digital signage applications. The most popular method is video streaming over the Internet, i.e., Internet Protocol (IP) networks. Video streaming usually works at protocol layer 3, i.e., Transmission Control Protocol (TCP/IP) or User Datagram Protocol (UDP/IP). In these cases, the sources function as servers and the displays function as clients. Display clients need to know the addresses of the source servers from which the clients receive the content to send requests to the servers to initiate video streaming sessions. Each display may initiate the video/audio streaming at a different time, which will result in out-of-sync video/audio. This is unacceptable in digital signage applications. Also, for simple receivers that need to be pre-configured with a server address, it is not possible to dynamically switch sources. To change the server address of these receivers, out-of-band control commands must be sent to the receiver. A receiver with such capabilities will be as complicated as a personal computer.

It is thus a challenge to achieve the level of controllability found in specially designed video switches while simultaneously taking advantage of Internet technology.

### SUMMARY OF THE INVENTION

The present invention relates to a method and system for virtual switching of video/audio contents and control signals for digital signage applications utilizing port-based broadcast Virtual Local Area Networks (VLAN). A virtual switching system is composed of one or more managed Ethernet switches. The content and control signals of the video/audio are delivered at protocol layer 2, i.e., the Ethernet layer. Each video source has a dedicated VLAN and displays switch to a specific source by joining the dedicated VLAN. The virtual switching through dynamically configured VLAN is controlled by centralized software. Consequently, the invention can achieve the level of controllability found in specially designed video switches while simultaneously taking the advantage of Internet technology.

### BRIEF DESCRIPTION OF THE DRAWINGS

FIG. 1 is an illustration of the transmitter that converts video/audio source and auxiliary control signals into Ethernet packets and the receiver that converts these Ethernet packets back into the original video/audio and auxiliary control signals. It provides only extension and is a special case in which dynamic switching is not needed.

FIG. 2 is a diagram illustrating one-to-multiple distribution using the transmitter and receiver described in FIG. 1 and an Ethernet switch. It provides only distribution and is a special case in which dynamic switching is not needed.

FIG. 3 illustrates the method of dynamic switching of video/audio and auxiliary control signals using port-based broadcast VLAN in accordance with the present invention.

FIG. 4 is a reference of a video switch matrix comprising of multiple managed Ethernet switches such that each display can be switched independently to any video source.

FIG. 5 describes a reference of a distributed video switch comprising of managed Ethernet switches located apart from each other and linked through high-bandwidth trunks.

### DETAILED DESCRIPTION OF THE INVENTION

Traditionally, digital signage applications use specially designed video extenders, distributors, and switches, which are usually expensive analog professional A/V equipment. Video sources and displays have, however, moved mostly from analog to digital in recent years. In order to use analog video extenders, distributors, and switches, digital signals must be converted to analog at the transmitter side and the resulting analog signals must be converted back to digital at the receiver side. This, in addition to increasing cost, also degrades video quality. Consequently, there is a need to upgrade the video extension, distribution, and switching infrastructure to full digital for digital signage applications.

There are two approaches for the above-mentioned upgrade. One is to follow the same philosophy as analog professional A/V equipment: specially designed analog video extenders, distributors, and switches are simply upgraded to their digital counterparts. Unfortunately, this approach is also expensive.

Obviously, there is a need to reduce the overall cost of digital signage applications by delivering through commonly available means. Another approach is to use Internet technology and the ubiquitous Internet infrastructure. The functional boundaries found in extenders, distributor, and switches disappear. Video content is delivered from sources to displays simply as digital data, i.e., packets, and the functionality of extension, distribution, and switching is achieved seamlessly.

Internet technology by its nature is a peer-to-peer communication protocol, and Internet applications in most of the cases follow the server-client mode. In short, Internet technology is not designed for centralized control.

When Internet technology is used for digital signage applications, the same server-client mode is followed. Video sources work as servers and displays work as clients. Video servers provide content service upon request to the displays. It is the display that actively decides what contents it displays. However, the server-client mode apparently does not align with digital signage applications because by nature, digital signage is a central control application. Therefore, a need exists for a centralized control mode to deliver video content over the Internet.

The main function of a digital signage application is to deliver video/audio content from sources to displays under central control. Other auxiliary functions, such as turning the power supply of the displays on and off remotely, are often needed in practical applications. These auxiliary functions are normally implemented through a separate control system working in parallel with the video/audio delivery system. The integration of auxiliary control functions and video/audio delivery function into one system is much needed to reduce cost and enhance reliability.

The previously mentioned needs are fulfilled with the present invention. By converting video/audio and auxiliary control signals into Ethernet packets, both video/audio and auxiliary control signals can be transported through the same path. By utilizing port-based broadcast VLAN, both video/audio and auxiliary control signals can be switched in the same way under centralized software control.

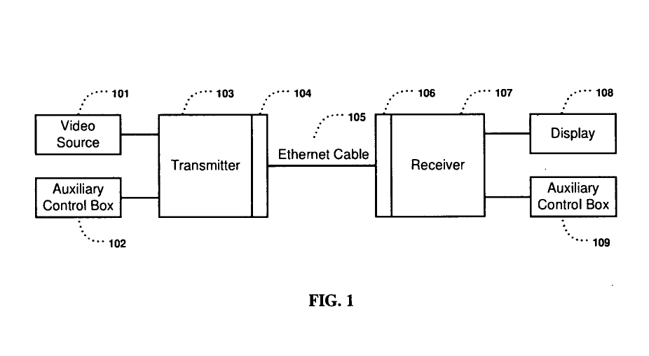

Illustrated in FIG. 1 is a transmitter that converts video source and auxiliary control signals into Ethernet packets and sends the packets over a standard Ethernet cable using Ethernet protocol and a receiver that converts these incoming packets back into their original forms. It forms an extension of video/audio and auxiliary control signals using the Ethernet standard.

Video Source 101 is digital video and can be compressed or uncompressed, high definition or standard definition, and TV or computer video.

Auxiliary Control Boxes 102 and 109 have interfaces such as USB, IR, serial port, I/O inputs and outputs etc. The auxiliary control signals can be either unidirectional or bi-directional.

Transmitter 103 compresses the video if it is not already compressed and converts the compressed video and auxiliary control signals into standard Ethernet packets to be sent out using broadcast MAC address as the destination address. Each type of auxiliary control signal has its own protocol type and the video/audio may have multiple protocol types depending on its compression format, which can be MPEG2, MPEG4, H.264, or proprietary formats. For bi-directional auxiliary control signals, Transmitter 103 receives only the Ethernet packets that match its MAC address and converts the incoming packets back to the original auxiliary control signals.

Interfaces 104 and 106 are standard RJ-45 Ethernet connectors. Ethernet cable 105 is a standard CAT5, CAT6, or CAT7 crossover cable. The bandwidth can be any Ethernet standard, but must be full duplex, such as 10 Mbps, 100 MMbps, 1 Gbps, or 10 Gbps full duplex.

Receiver 107 uncompresses the video and converts the incoming packets back into video/audio and auxiliary control signals and sends them to the display or auxiliary control box respectively. For bi-directional auxiliary control signals, Receiver 107 converts the auxiliary control signals into standard Ethernet packets to be sent out using the MAC address of Transmitter 103 as the destination address. Each type of auxiliary control signal has its own protocol type, which is defined similarly at both Transmitter 103 and Receiver 107.

Display 108 is a digital flat panel and is connected to the receiver through a digital interface such as High-Definition Multimedia Interface (HDMI) or Digital Visual Interface (DVI).

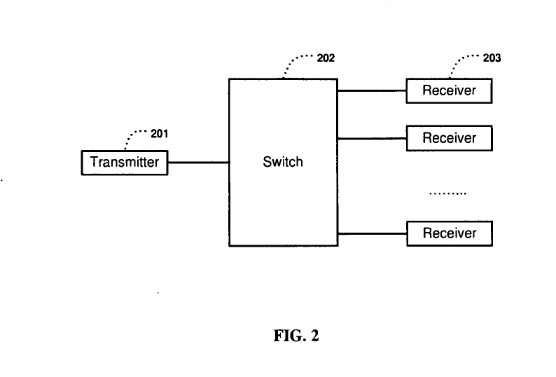

FIG. 2 illustrates a form of distribution for video/audio and auxiliary control signals comprising of one transmitter, multiple receivers, and an Ethernet switch. For simplicity, the video source, auxiliary control boxes, and displays are omitted.

Ethernet Switch 202 can be either managed or non-managed because dynamic switching is not needed for this distribution function; physically, it can be one Ethernet switch or a collection of switches. Ethernet Switch 202 operates in full duplex mode and treats the transmitter and receivers equally. Any valid broadcast Ethernet packets received at one port are duplicated at all its other ports. Unicast Ethernet packets are only forwarded to the port that matches its destination MAC address.

Transmitter 201 functions the same way as the Transmitter 103 illustrated in FIG. 1. It must have a unique MAC address and must be the only transmitter because it sends all its packets to Ethernet Switch 202 as broadcast packets. Transmitter 201 only receives and processes packets that match its MAC address. Each type of auxiliary control signal has its own protocol type, but Ethernet packets with the same protocol type can be received from different receivers. Packets of the same type from the same receiver must be properly assembled to restore the original control signal. However, Transmitter 201 will not validate auxiliary control signals before forwarding them to an auxiliary control box. For example, control signals of the same type received from different receivers are forwarded even though the control signals are conflicting. It is up to the upper layer to handle this situation.

Receiver 203 and all the receivers in FIG. 2 function the same way as Receiver 107 in FIG. 1. Each receiver must have a unique MAC address. The receivers receive broadcast packets and learn the MAC address of the transmitter from the source address of these packets. The receivers can only send unicast packets and their destination MAC addresses can only be the addresses of the receiver's corresponding transmitter. The receivers will not validate auxiliary control signals before forwarding them to an auxiliary control box.

All the interfaces between the Ethernet switch and the transmitter or the receivers are standard RJ-45 Ethernet connectors, and all the cables are standard CAT5, CAT6, or CAT7 cables. The bandwidth of the interfaces does not need to be the same as long as all interfaces have sufficient bandwidth.

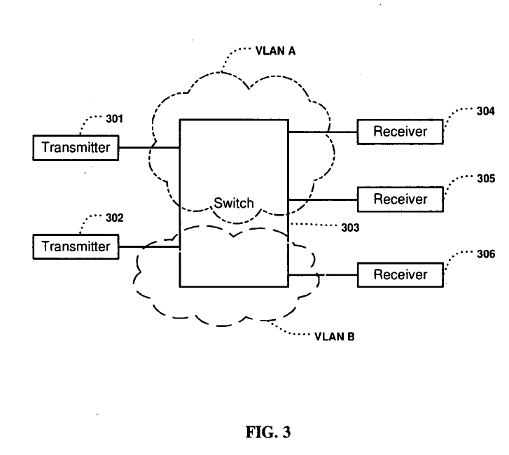

FIG. 3 illustrates the dynamic switching of video/audio and auxiliary control signals provided by the present invention, in which multiple transmitters (video sources) and multiple receivers (displays) are presented. For simplicity, the video source, auxiliary control boxes, and displays are omitted. The transmitter and video source can be used interchangeably; the same is true with the receiver and display.

Ethernet Switch 303 must be a managed switch. A managed switch can create VLAN dynamically either by text-based commands through a console or through protocols such as the Simple Network Management Protocol (SNMP) or Multiple VLAN Registration Protocol (MVRP). Logically, a port-based VLAN works in the same fashion as a non-managed Ethernet switch. A port that belongs to a port-based VLAN is a member of the VLAN. Any valid broadcast Ethernet packets received at a member port are duplicated at all the other member ports of the VLAN. Unicast Ethernet packets are only forwarded to the member port that matches its destination MAC address.

Ethernet Switch 303 can be one managed Ethernet switch or a collection of managed switches. Ethernet Switch 303 operates in full duplex mode and treats the transmitter and receivers equally. Ethernet Switch 303 must support full line rate. For example, for a 24-port Gigabit switch, it must have 48 Gigabit total bandwidth.

Transmitter 301 and the transmitters in FIG. 3 function the same way as the Transmitter 103 illustrated in FIG. 1. When a video source is added, a new VLAN is created with a unique VLAN ID.

Receiver 304 and all the receivers in FIG. 3 function the same as Receiver 107 in FIG. 1. When a display is added, it receives content from one of the video sources by joining the specific VLAN according to its unique VLAN ID.

When Receiver 305 is switched from one source, assuming its VLAN ID is A, to another source, assuming its VLAN ID is B, the receiver is removed from VLAN A and added to VLAN B. The switching takes some time and may also cause incomplete packets or auxiliary control signals. To avoid glitches or blank screens on the displays, the receivers must have the ability to continuously play the last received good video frame if no good incoming video packets are received for a short period of time. The receivers can stop video outputs if no good incoming video packets are received for an extended period of time. The receivers and transmitters must have the ability to detect and discard incomplete auxiliary control signals to void the forwarding of erroneous control signals to the auxiliary control boxes.

Two aspects of the invention need to be emphasized: First, the creation and deletion of VLANs, as well as the release from and joining of VLANs are fully controlled by centralized software. Second, both video packets and auxiliary control packets travel exactly the same path and are switched at the same time.

The centralized software is the key to the invention and normally runs on a dedicated computer workstation, such as a Unix, Linux, PC, or MAC machine. It may also have a warm backup workstation to achieve full redundancy. It configures, controls, and manages the Ethernet switches through their management ports normally over a separate IP network. It performs three major functions: provisioning, switching, and performance management.

Provisioning can be done offline or online and results in a database which contains a set of mathematical models that fully describes the internal topology of the virtual switch, the VLAN configurations, and the initial connections between the sources and the displays. After power up, the centralized software sets up the initial state of the virtual switch based on the models in the database. Switching is done in real-time, and if successful, any changes are also saved to the database. Performance management is done through periodical polling.

The centralized software could be Command Line Interface (CLI) based or Graphics User Interface (GUI) based.

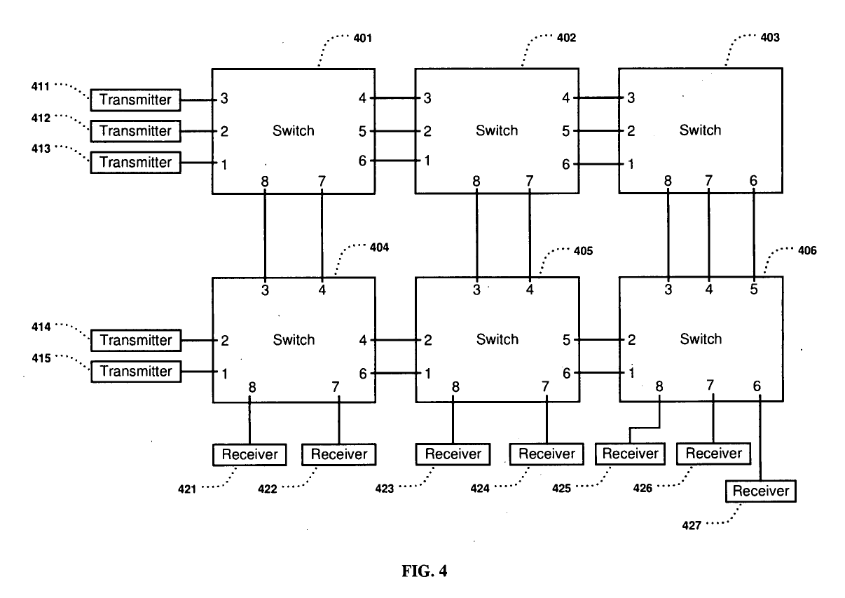

FIG. 4 illustrates a 5×7 switch matrix comprising of six 8-port managed Ethernet switches, in which any of the seven displays (receivers) can be independently switched to any of the five sources (transmitters). Illustrated in FIG. 4 is a reference to the method described in FIG. 3 in accordance with the present invention.

Switches 401, 402, 403, 404, 405 and 406 must be managed Ethernet switches. Each switch must have an extra management port through which software can configure the VLAN dynamically. All eight ports of each switch normally have the same bandwidth. The ports connected to either the transmitters or the receivers, i.e., ports 1, 2, and 3 of Switch 401, ports 1, 2, 7 and 8 of Switch 404, ports 7 and 8 of Switch 405, and ports 6, 7 and 8 of Switch 406 must be untagged; the rest of the ports can be tagged or untagged.

When Transmitter 411 is added, a VLAN with a VLAN ID of A is created on all six switches. The initial members of VLAN A should include ports 3 and 4 of Switch 401, ports 3 and 4 of Switch 402, and port 3 of Switch 403.

When Transmitter 412 is added, a VLAN with a VLAN ID of B is created on all six switches. The initial members of VLAN B should include ports 2 and 5 of Switch 401, ports 2 and 5 of Switch 402, and port 2 of Switch 403.

When Transmitter 413 is added, a VLAN with a VLAN ID of C is created on all six switches. The initial members of VLAN C should include ports 1 and 6 of Switch 401, ports 1 and 6 of Switch 402, and port 1 of Switch 403.

When Transmitter 414 is added, a VLAN with a VLAN ID of D is created on all six switches. The initial members of VLAN D should include ports 2 and 5 of Switch 404, ports 2 and 5 of Switch 405, and port 2 of Switch 406.

When Transmitter 415 is added, a VLAN with a VLAN ID of E is created on all six switches. The initial members of VLAN E should include ports 1 and 5 of Switch 404, ports 1 and 6 of Switch 405, and port 6 of Switch 406.

If a connection between Transmitter 411 and Receiver 421 is required, then port 8 of Switch 401 and ports 3 and 8 of Switch 404 are added to VLAN A.

If a connection between Transmitter 414 and Receiver 422 is required, then port 7 of Switch 404 is added to VLAN D.

If a connection between Transmitter 412 and Receiver 423 is required, then port 8 of Switch 402 and ports 3 and 8 of Switch 405 are added to VLAN B.

If a connection between Transmitter 415 and Receiver 424 is required, then port 7 of Switch 405 is added to VLAN E.

If a connection between Transmitter 413 and Receiver 425 is required, then port 8 of Switch 403 and ports 3 and 8 of Switch 406 are added to VLAN C.

If a connection between Transmitter 414 and Receiver 426 is required, then port 7 of Switch 406 is added to VLAN D.

If a connection between Transmitter 415 and Receiver 427 is required, then port 6 of Switch 406 is added to VLAN E.

When Receiver 427 is required to switch from Transmitter 415 to 411, port 6 of Switch 406 is first removed from VLAN E. Then, port 6 of Switch 403 and ports 5 and 6 of Switch 406 are added to VLAN A. Any other switching can be executed in the same fashion.

The reference as illustrated in FIG. 4 can be easily expanded. To expand the number of transmitters, more rows can be added: if a row of the same type were added in FIG. 4, the total number of transmitters would increase to seven. To expand the number of receivers, more columns can be added: if a column of the same type were added in FIG. 4, the total number of receivers would increase to nine.

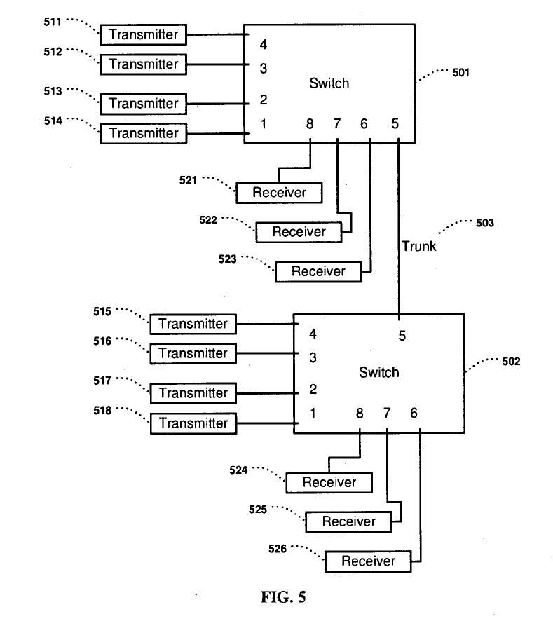

FIG. 5 depicts a distributed video switch comprising of two 8-port managed Ethernet switches linked together through a high-bandwidth trunk. Portrayed in FIG. 4 is a reference to the method described in FIG. 3 in accordance with the present invention.

Switches 501 and 502 must be managed Ethernet switches. Each switch must have an extra management port through which software can configure the VLAN dynamically. The ports configured as trunk, i.e., port 5 of Switch 501 and port 5 of Switch 502, normally have higher bandwidths and must be tagged; the ports connected to either the transmitters or the receivers, i.e., ports 1, 2, 3, 4, 6, 7, and 8 of Switch 501 and ports 1, 2, 3, 4, 6, 7, and 8 of Switch 502 must be untagged.

The bandwidth of Trunk 503 is shared. Trunk 503 can be a Wide Area Network (WAN) link if Switch 501 and 502 are remotely located.

When Transmitter 511 is added, a VLAN with VLAN ID of A is created on the two switches; the initial members of VLAN A should include ports 4 and 5 of Switch 501, and port 5 of Switch 502. Similarly, VLAN B, C and D are created for Transmitter 512, 513 and 514.

When Transmitter 515 is added, a VLAN with a VLAN ID of E is created on the two switches. The initial members of VLAN E should include ports 4 and 5 of Switch 502 and port 5 of Switch 501. Similarly, VLAN F, G, and H are created for Transmitter 516, 517, and 518.

Receivers 521, 522, 523, 524, 525, and 526 can switch to any of the transmitters by dynamically joining their corresponding VLANs. The receivers can switch to local transmitters without any limitations. However, limitations may exist when switching to remote transmitters depending on the available bandwidth of Trunk 503.

Thus, it is apparent that there has been provided, in accordance with the present invention, a virtual video switch that can switch video/audio and auxiliary control signals at the same time and the method through which centralized software is used to initiate switching, both of which fully meet the goals set forth previously. Although the invention has been described and illustrated with reference to specific embodiments, it is not intended that the invention be limited to these illustrative embodiments. Those skilled in the art will recognize that modifications and variations can be made without departing from the spirit of the invention. For example, managed Ethernet switches of various sizes and interfaces of various bandwidths can also be used to create many new combinations. Also, in addition to USB, IR, serial port, and I/O inputs and outputs, auxiliary control signals may also include measurements of ambient brightness and temperature where displays are installed. Therefore, it is intended that this invention encompass all such variations and modifications as fall within the scope of the appended claims.

What is claimed is:

1. A method and system for virtually switching different types of data traffic, including different formats and definitions of digital video/audio and auxiliary control signals for digital signage applications utilizing port-based broadcast Virtual Local Area Networks (VLAN).

2. The method of claim 1, wherein port-based broadcast VLANs are created for each of the video sources and all the digital signage displays joined to the VLAN display the same content.

3. The method of claim 1, wherein dynamically moving displays from one VLAN to another achieves video switching from one source to a second source.

4. The method of claim 3, wherein switching displays between VLANs is controlled remotely by centralized software.

5. The method of claim 4, wherein the centralized software reconfigures VLANs through either proprietary interfaces or standard interfaces, such as Simple Network Management Protocol (SNMP) and Multiple VLAN Registration Protocol (MVRP).

6. The method of claim 1, wherein the auxiliary-control signals include serial ports, USB mouses, USB keyboards, and generic I/O controls.

7. The method of claims 1, wherein different types of traffic are multiplexed and de-multiplexed according to their protocol types.

8. The system of claim 1, wherein virtual video switches are implemented using one or more managed Ethernet switches.

9. The system of claim 8, wherein virtual video switches can be either full or partial matrix switches.

10. The system of claim 8, wherein the managed Ethernet switches can be a combination of any port size, including, 4-port, 8-port, 16-port, 32-port, and 64-port, and the multiple small switches can be cascaded to form large switches with higher port numbers.

11. The system of claim 8, wherein the managed Ethernet switches can be a combination of any port bandwidth, including 100 Megabits, 1 Gigabits, and 10 Gigabits.

12. The system of claim 8, wherein the managed Ethernet switches can be placed at the same location to form a centralized video switch or at multiple remote locations and linked through high-bandwidth trunks to form a distributed video switch.

13. The system of claim 1, wherein digital video can be compressed using either proprietary formats or standard formats, including MPEG1, MPEG2, MPEG4, and H.264.

14. The system of claim 13, wherein the format and definition of the video can be Standard Definition Television (SDTV), High Definition Television (HDTV), or any standard computer video, including XGA, SXGA, UXGA, QXGA, WSXGA, WUXGA, WQXGA.
